(19) United States
(12) Patent Application Publication
(10) Pub. No.: US 2004/0233928 A1
(43) Pub. Date: Nov. 25, 2004

(54) Network topology and packet routing method using low voltage power wiring

(75) Inventor: Andrew Pozsgay, Annapolis, MD (US)

Correspondence Address: CROWELL & MORING LLP, INTELLECTUAL PROPERTY GROUP, P.O. BOX 14300, WASHINGTON, DC, 20044-4300, US

(73) Assignee: TELKONET, INC.

(21) Appl. No.: 10/430,282

(22) Filed: May 7, 2003

(51) Int. Cl. H04L 12/413

(52) U.S. Cl. 370/446; 370/463

(57) ABSTRACT

A network topology and packet routing method for implementing a Local Area Network (LAN) using low-voltage (120/240VAC) power wiring as the transport medium. An Access Point (AP) having a Power Line Carrier (PLC) interface and one or more IEEE 802.3 Ethernet interfaces connects to the logical center of the Power Line medium via its PLC interface. Multiple User Terminals (UT) send to and receive from their associated AP, which in turn routes data packets toward the appropriate destination. Large networks may contain more than one AP, in which case each UT selects its AP based on a metric representing connection quality between the UT and the AP.

### FIELD OF THE INVENTION

The invention relates to packet data networks in general and in particular to topologies and packet routing methods in Local Area Networks (LANs) implemented using Power Line Carrier (PLC) technology.

### BACKGROUND OF THE INVENTION

In-building LANs are commonly implemented over twisted-pair cabling using the IEEE 802.3 access method and physical layer specification. Using this method, one or more hubs or switches are installed in centralized location(s) in the building, typically a wiring closet. Twisted-pair cabling is run from this closet to each user location, one cable per user. All hubs/switches are then connected together using the same type cable.

One advantage of this wired method is twisted-pair cabling provides a reliable communications medium capable of rejecting external interference. Another advantage is each user can use the full capacity of the medium without having to share it with others, provided switches are used as the interconnects.

The main disadvantage of twisted-pair cabling is the expense of the cable installation. If the cabling is installed at the time of building construction, the task is fairly straightforward. However, many existing buildings did not have this cabling installed at the time of construction. Retro-fitting these buildings can be a prohibitively large and complex task.

In situations where twisted-pair cable installation is not practical, PLC is an attractive alternative. The Power Line as a communications medium presents challenges to the system designer, including impedances that vary with frequency and time, and noise sources from appliances connected to the network. It has been shown, however, that advanced modulation techniques such as Orthogonal Frequency Division Multiplexing (OFDM) along with error control coding can overcome these challenges and make low-voltage AC power lines usable as a communications channel using the relatively quiet spectrum above 1 MHz.

FIG. 1 depicts an example of a typical electrical wiring installation for a small to medium size commercial building. The thick lines represent high-current 3-phase wiring and the thin lines represent lower current (15-20 A) wiring. The shaded boxes represent outlets, which are the locations at which users can access the network via a UT.

At the frequencies of interest to PLC, this wiring network does not present a controlled impedance. Impedance discontinuities exist at every wire termination point, including outlets and panel connections. As an example, the path between outlet A and outlet B contains 9 impedance discontinuities (A₁, A₂, A₃, Sub Panel 1, Main Panel, Sub Panel 2, B₃, B₂, B₁). Upon reaching each one of these discontinuities, some signal power is reflected back toward the transmitter and impairs the channel.

The electrical panels introduce another mechanism to impair the channel. When a signal encounters a panel, some power flows out through each wire connected to the panel. In this way, the panel acts as a power divider. The panel attenuates the signal because only a fraction of the power sent into the panel goes toward the intended destination. The rest of the power is effectively lost.

It can be seen that a user on a subpanel 1 outlet attempting to communicate directly with a user on a subpanel 2 outlet encounters a number of channel impairments. As an example, the path from outlet A, to outlet B, contains 9 separate sources of channel impairment. 6 of these are outlet terminations, which mainly insert impedance discontinuities. The other 3 are panels which insert attenuation in addition to impedance discontinuities.

Whereas in the electrical installation depicted in FIG. 1 uses 120V/220V wiring to distribute electrical power within the building, it is also common to use a higher voltage such as 480V for long high-power runs and then step down to 120V for local distribution. The higher voltage reduces the current which allows use of a smaller-gauge wire. FIG. 2 depicts such an installation. The power transformers commonly used in these applications present a significant barrier for signals in the PLC frequency range, further decreasing the likelihood that a node can directly communicate with a node on a different subpanel.

### SUMMARY OF THE INVENTION

The invention is a network topology and packet routing method for providing LAN connectivity over in-building AC power wiring. The network consists of one or more APs, one or more UTs, and the power wiring (the medium). The AP(s) is (are) installed in locations representing the logical center of the entire in-building wiring network or the center of a portion of it. The UTs communicate only with their corresponding AP, who in turn routes the packets toward their destination.

It is an object of the present invention to provide a system using a Power Line Carrier for network communication by installing an AP at one or more electrical panels and connecting these APs together using standard Ethernet links over twisted-pair cabling. For network management purposes, it is desirable to designate one of the APs as a primary and the others secondaries. Therefore, this network contains three types of device: Primary AP, Secondary AP, and UT.

It is clear that by inserting an Access Point (AP) at the Main panel, and routing all packets through that AP, the worst-case scenario for a channel between any two users is significantly improved. Instead of a single hop with 9 impairments (6 outlets and 3 panels), a user on outlet A can reach a user on outlet B via 2 hops with 5 impairments each (3 outlets and 2 panels). In a building of sufficient size, the insertion of one or more APs will enable communication between users who previously could not communicate with each other.

In a multi-AP installation, a given UT may be able to communicate to some degree with more than one AP. In this case, the UT selects the most appropriate AP to use by estimating the speed with which it can communicate with each AP and selecting the AP with which it can communicate with at the highest rate.

Nodes which make use of the invention are referred to as endpoints. Endpoints can be connected to the Ethernet interface of either an AP or a UT, possibly through one or more standard Ethernet hubs or switches. The present invention provides transport of Ethernet frames from a source endpoint to one or more destination endpoints.

Other objects, advantages and novel features of the present invention will become apparent from the following detailed description of the invention when considered in conjunction with the accompanying drawings.

### BRIEF DESCRIPTION OF THE DRAWINGS

FIG. 1 has a typical electrical wiring installation for a small to medium size commercial building or multi-tenant unit;

FIG. 2 has a installation similar to FIG. 1 using a medium voltage feed and step down transformer;

FIG. 2a illustrate connections between access points (AP) of different sub-panels;

FIG. 3 shows the architecture which make up the primary access point (PAP), the secondary access point (SAP) and the user terminal (UT) hardware in the present invention;

FIG. 4 is a schematic illustrating an example of the user terminal hardware environment;

FIG. 5a shows a structure for frames which are received from or transmitted to a user terminal and which have a standard Ethernet frame structure according to IEEE 802.3 format;

FIG. 5b illustrates a structure for frames transferred over power wiring (PLC);

FIG. 5c shows structure for frames transferred between a primary access point (PAP) and a secondary access point (AP);

FIG. 6a is a table stored in the PAP with indexing of the SAPs;

FIG. 6b is a Proxy table in the PAP indexing the user terminals (UT);

FIG. 6c is a PAP table of all end points;

FIG. 6d is a listing of entries in a UT Ethernet end point table;

FIG. 7 is a flow chart of PAP packet processing;

FIG. 8a is a flow chart of the transmission of a frame to a UT;

FIG. 8b is a flow chart of the power line broadcast method;

FIG. 9 is a flow chart of SAP processing flow; and

FIG. 10 is a flow chart of UT processing flow.

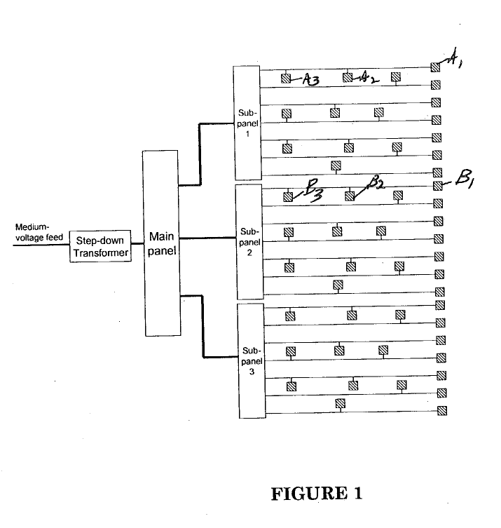

### DETAILED DESCRIPTION OF THE PREFERRED EMBODIMENTS

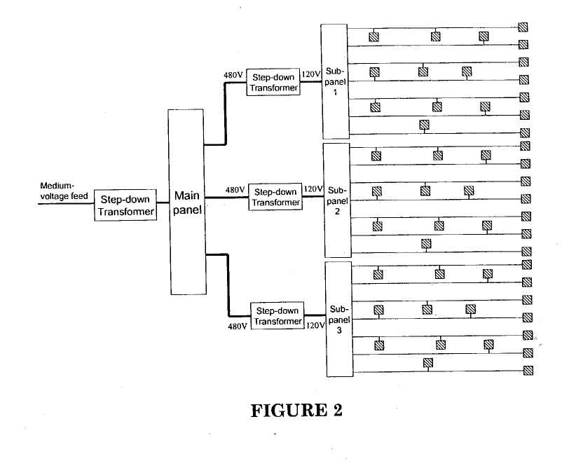

FIG. 2a show a connection of access points 11 and 17 within sub-panels 10 and 16. User terminals 20 and 20′ are connected to the respective access point 11 and 17 by the power line carrier. Communication between access points 11 and 17 is accomplished through an Ethernet connection directed by hub 15. All signals received by hub 15 are directed to all access points with the receipt of these signals based on the address so that access points for which signals are not destined will not be accepted. Although structure 15 is shown as a hub, in other embodiments device 15 can be an Ethernet switching device used whereby signals are not sent to all Access Points (AP) but only to the intended Access Points (AP). Additionally, signals may be sent from the hub (15) to external devices such as the Internet.

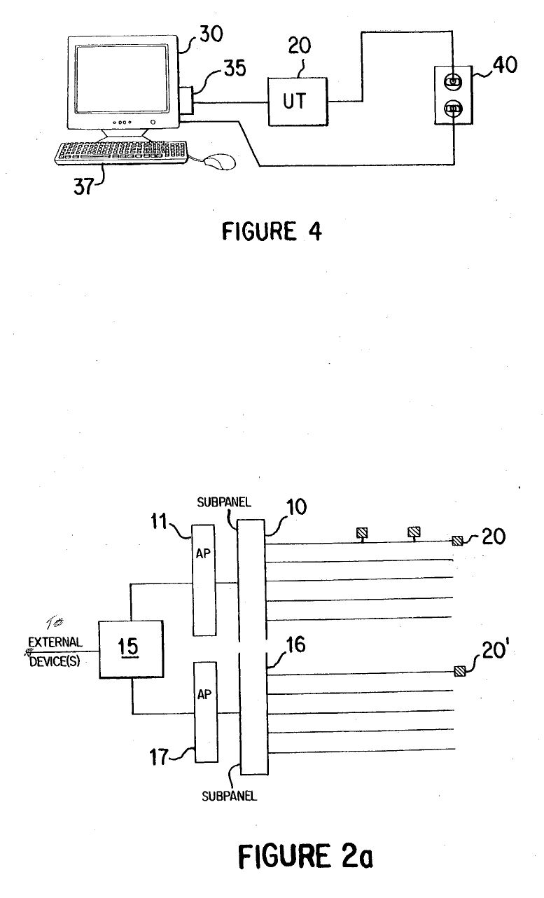

The Primary AP (PAP), Secondary AP (SAP), and UT hardware all share the common architecture depicted in FIG. 3, which can be viewed as a microprocessor with two interfaces: one Ethernet and one PLC. The Ethernet interface works as follows. The Ethernet MAC (Medium Access Protocol) sends and receives IEEE 802.3 Ethernet frames using the Ethernet Physical Layer (PHY) transceiver, which in turn connects to a twisted-pair medium. Frames received on the twisted-pair are demodulated by the PHY, forwarded on to the MAC for frame synchronization and error-checking, and then placed in the shared RAM to be read by the microprocessor. Frames to be transmitted on the twisted-pair are written to the shared RAM, read by the MAC, and then transmitted on the medium via the PHY.

The PLC interface is similar to the Ethernet interface in that it sends and receives similarly formatted frames and the data path is the same. The main differences are in the nature of the MAC and PHY. The modulation method used by the PHY is one appropriate for use over a power wiring network. Similarly, the medium access protocol used by the MAC is one optimized to perform well under the channel conditions found in a power wiring network.

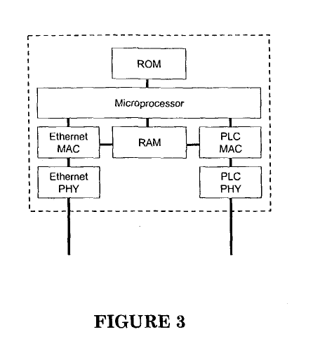

The user terminal UT constructed in accordance with FIG. 3 is part of an end point structure of the type illustrated in FIG. 4 wherein User Terminal 20 is shown as receiving an output from Ethernet card 35 of the PC 30 with its associated input keyboard 37. The output of User Terminal 20 is fed to the ordinary power line connection point 40 having 2 terminals. One of the terminals is connected as a source of power for the PC while the other carries the output signal from the user terminal to be provided for transmission over the PLC (power line carrier). Although the user terminal is shown as outside of the PC, in another embodiment it could be positioned inside the PC in addition to or as part of the Ethernet card.

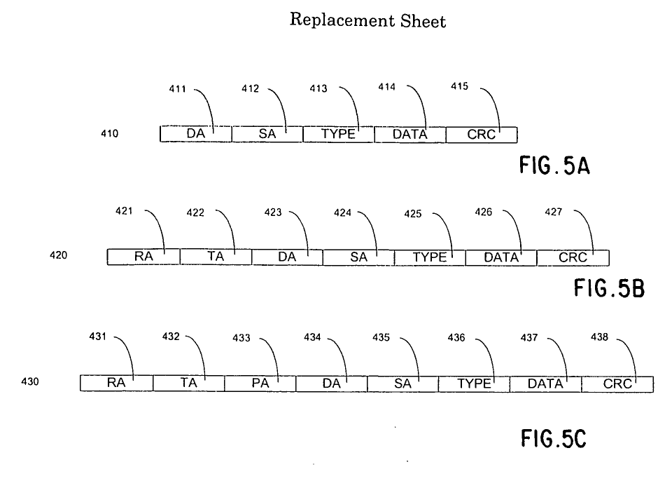

When a frame is received on either the PLC or the Ethernet interface, the frame is written to RAM and the microprocessor is notified of the frame's arrival. The microprocessor examines the frame header and, based on this header and the contents of bridging tables stored in RAM, retransmits the frame on one or both interfaces, possibly modifying the header first. Frames transferred over twisted-pair Ethernet can be either External frames or AP-to-AP frames. External frames are standard Ethernet frames which are received from or transmitted to an endpoint, and have the standard IEEE 802.3 format (410) illustrated in FIG. 5a.

The Destination Address (DA) (411) is a 48-bit Ethernet address representing the ID of the station that is the intended recipient of the frame. The Source Address (SA) (412) is a 48-bit Ethernet address representing the ID of the station that is the originator of the frame. These fields are preserved as the frame passes through an Ethernet-to-Ethernet MAC layer bridge. The TYPE (413) field is a 16-bit identifier that is also referred to as the protocol ID. This field indicates which higher-layer protocol the frame belongs to, and defines the format of the variable-length DATA section (414). The CRC (Cyclic Redundancy Check) (415) is a 16-bit field used to verify the integrity of the frame.

Frames transferred over power wiring have the format of (420) as shown in FIG. 5b. The Receiver Address (RA) (421) is an address representing the ID of the PLC interface that the frame is immediately directed toward. The Transmitter Address (TA) (422) represents the ID of the PLC interface transmitting the frame. The remaining fields have the same meaning as in (410).

AP-to-AP frames are transferred between the PAP and a SAP and have the format of (430) shown in FIG. 5c. The RA (431) represents the frame's immediate receiver, and will either be the address of the PAP or a SAP, depending on the frame's direction. AP-to-AP frames can be either downstream or upstream. Downstream frames originate from a non-AP node connected off the PAP's Ethernet interface and terminate at a node connected to a UT. Upstream frames originate from a node connected to a UT and terminate at a non-AP node connected off the PAP's Ethernet interface. The Proxy Address (PA) (433) field represents the address of the UT which is “proxy” for the DA node. For downstream frames, the SAP forwards the frame to the UT whose address is PA (433), and this UT in turn forwards the frame to its Ethernet interface, where the frame reaches the endpoint with address DA (434). For upstream frames, the PA (433) is used by the PAP to allow it to maintain its table of UTs, and endpoints reachable via each.

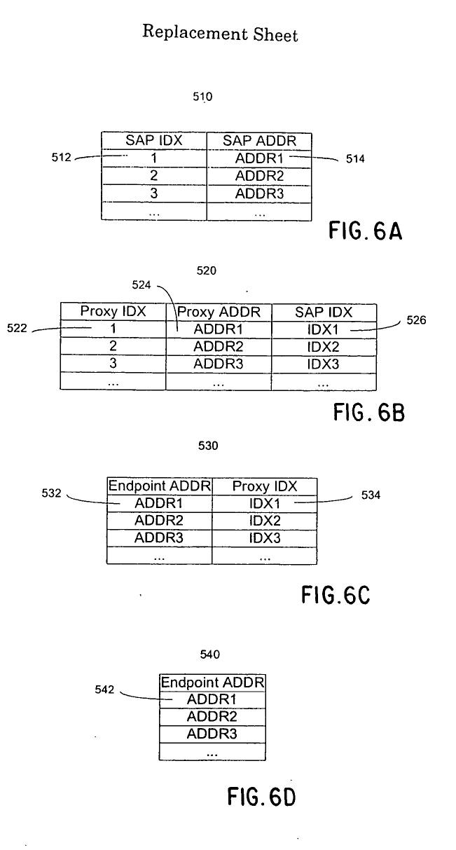

The differences between the PAP, SAP, and UT device types is in the way frames are routed between the two interfaces. The majority of the routing decision making is done at the PAP, which uses tables stored in its RAM in the decision process. One of these tables is the SAP table (510) of FIG. 6a, which is an indexed table of SAPs the PAP is aware of. The SAP IDX (512) of zero is reserved to represent the PAP.

Also in the PAP is the Proxy Table (520) of FIG. 6b, which is an indexed table of UTs the PAP is aware of. The Proxy IDX (522) of zero is reserved to represent the PAP Ethernet interface. The SAP IDX (526) represents the index of the SAP (512) in which the UT is reachable through. A SAP IDX (526) of zero means the UT is reachable directly via the PAP's PLC interface.

A third PAP table is the Endpoint Table (530) of FIG. 6c, which is a table of all endpoints the PAP is aware of.

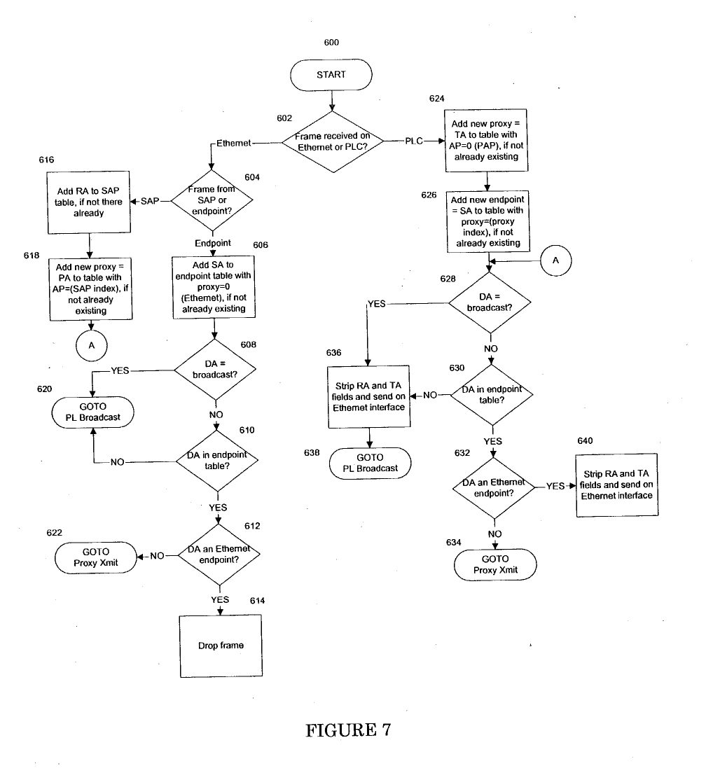

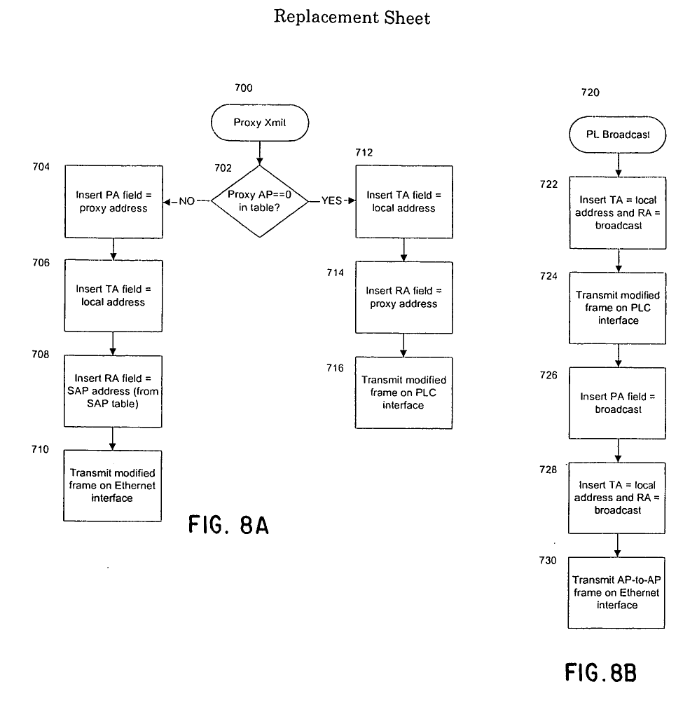

The PAP packet processing flow is illustrated in (600) of FIG. 7. A frame received on the PLC interface is could have only come from a UT (proxy) and is in the format of (420). The TA (422) is the proxy address and is added to the proxy table if a corresponding entry does not already exist (624). The SAP IDX field (526) corresponding to this entry is set to zero to indicate the proxy is reachable directly from the PAP. The SA (424) is the source address of the endpoint that sent the frame and this endpoint is added (626) to the endpoint table (530) if it does not already exist. The Proxy IDX (534) corresponding to the endpoint is set to the index of the proxy in the proxy table (522) corresponding to the TA (422). The DA field (423) is then examined (628) to determine if the frame is a broadcast type. If it is, the RA (421) and TA (422) fields are removed from the frame the remaining frame is transmitted on the Ethernet interface (636). Also, the frame is broadcast to all powerline nodes by means of the PL Broadcast method (720) shown in FIG. 8b. If the frame is not a broadcast, the DA (423) is compared against all nodes (630) in the endpoint table (530) to determine if the location of the destination node is known. If the DA (423) does not match any node in the endpoint table (530), control transfers to block (536) and the frame is sent out to the Ethernet interface and all proxies. If the DA (423) does match an endpoint table (530) entry, the proxy index field for that entry (534) is examined (632) to determine the location of the destination endpoint. If the Proxy IDX (534) equals zero, the endpoint is located on the Ethernet interface and the frame is transmitted there (640). If the Proxy IDX (534) is nonzero, the endpoint is located off a proxy and control transfers to the Proxy Xmit method (700) shown in FIG. 8a.

A frame received on a PAP's Ethernet interface is examined to determine if it came from a SAP or an endpoint (604). If it is from a SAP, it is in the format of (430) and the RA (431) is compared against the ADDR fields (514) of the SAP table (510), and the SAP is added to the table if it does not already exist (616). Then the PA field (433) is compared against the ADDR fields (524) of the proxy table (520), and a new proxy is added with ADDR=PA if one does not already exist (618). Control is then transferred to point (627). If the frame came from an endpoint, it is in the format of (410) and the SA (412) is compared against the ADDR fields (532) of all entries in the endpoint table (530) and a new entry is created if no match is found (606). Then the DA (411) is examined to determine if the frame is a broadcast type (608). If it is a broadcast, control transfers to the PL Broadcast method (720) shown in FIG. 8b. Otherwise, the DA (411) is searched in the ADDR fields (532) of the endpoint table (610). If the DA (411) is not found, control transfers to the PL Broadcast method (720). If there is a match, the Proxy IDX field (534) is examined (612) to determine the location of the destination endpoint. If the Proxy IDX (534) equals zero, the endpoint is located on the Ethernet interface and the frame is dropped because it has already reached its destination. If the Proxy IDX (534) is nonzero, the endpoint is located off a proxy and control transfers to the Proxy Xmit method (700).

The Proxy Xmit method (700) transmits a frame to a UT, either directly over the PLC interface or indirectly through a SAP. The SAP IDX field (526) in the proxy table is examined (702) to determine the route to reach the proxy. If SAP IDX (526) equals zero, the frame is sent on the PLC interface in the format of (420). The TA (422) field is set to the PAP address (712), the RA field (421) is set to the proxy address (714), and the frame is transmitted on the PLC interface (716). If SAP IDX (526) is nonzero, the frame is sent on the Ethernet interface in the format of (430). The PA field (433) is set to the proxy address (704), the TA field (432) is set to the PAP address (706), the RA field (431) is set to the address of the SAP corresponding to the SAP IDX (526) (708), and the frame is sent on the Ethernet interface (710).

The PL Broadcast method (720) sends a frame such that it reaches all endpoints reachable via a UT. To do this, the frame is broadcast on the PLC interface in the format of (420) and also broadcast on the Ethernet interface to all SAPs in the format of (430). For the PLC transmission, the TA (422) is set to the PAP address and the RA (421) is set to the broadcast address (722), and the frame is sent on the PLC interface (724). For the Ethernet transmission, the PA field (433) is set to the broadcast address (726), the TA (432) is set to the PAP address, and the RA (431) is set to the broadcast address (728), and the frame is transmitted on the Ethernet interface (730).

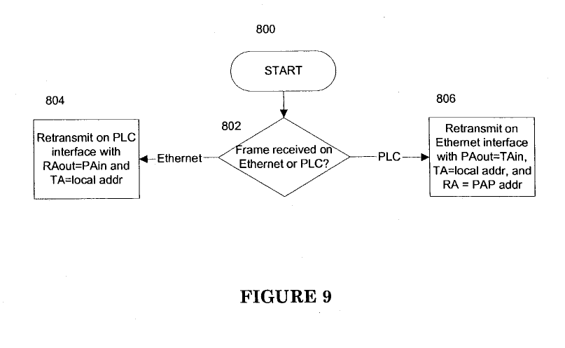

The SAP processing flow (800) is illustrated in FIG. 9. Frames received on the Ethernet interface are in the format of (430), and retransmitted on the PLC interface in the format of (420). The RA field (421) is set to the PA field (433) of the incoming frame and the TA field (422) is set to the SAP address (804). Frames received on the PLC interface are in the format of (420), and retransmitted on the Ethernet interface in the format of (430). The PA field (433) is set to the TA field (422) of the incoming frame, the TA field (432) is set to the SAP address, and the RA field (431) is set to the PAP address (806). Each SAP knows the address of the PAP because the PAP periodically broadcasts a frame in the format of (410), which announces itself as the PAP.

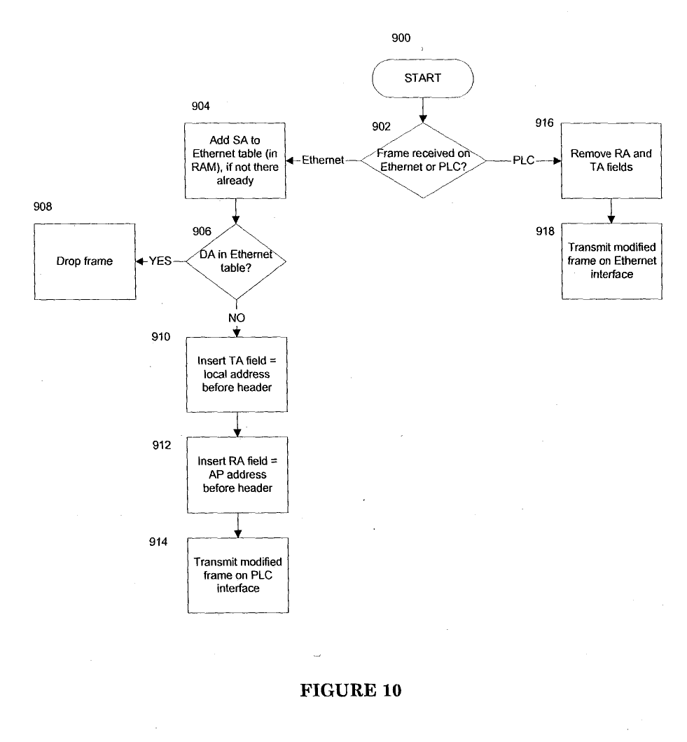

The UT processing flow (900) is illustrated in FIG. 10. When a frame is received on the Ethernet interface, its SA (412) is compared (904) against all entries in the UT Ethernet endpoint table, which has the format of (540) of FIG. 6d, and a new entry (542) is added if no match exists. Then, the DA (411) is compared (906) against entries in the same table (540). If the DA (411) exists, the frame is discarded (908). If the DA (411) does not exist, the frame is sent out on the PLC interface in the format of (420). The TA field (422) is set to the UT address (910) and the RA field (421) is set to the AP address (912). This AP address can be the address of the PAP or the address of a SAP, depending on which AP the UT selected as its AP. When a frame is received on the PLC interface, the RA (421) and TA (422) fields are stripped off (916) and the frame is sent (918) on the Ethernet interface in the format of (410). The following procedure is used by each UT to select its AP. The PAP and all SAPs periodically broadcast a frame in the format of (410) on their PLC interface, announcing themselves as an AP. Any UT capable of joining the network will be able to receive these frames from one or more APs. If a UT can receive these frames from only one AP, it selects that AP. If the UT can receive these frames from two or more APs, it estimates its connection speed with each AP, and selects the one with the highest speed. This connection speed may be obtained via several methods. This metric may be generated by the PLC MAC function and passed up to the packet routing function. Otherwise, the packet routing function may send a special frame type to each AP, which the AP immediately sends back to the UT. The UT measures the time elapsed between sending and receiving the packet, and selects the AP which it received the frame back from in the shortest time.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed:

1. A system for local area network communication comprising:
a low-voltage AC power wiring structure including a plurality of logical wiring centers each of said plurality of wiring centers associated with a respective plurality of electrical outlets;
a plurality of communication access points each installed in a respective one of said plurality of logical wiring centers;
a plurality of user terminals each connected to one of said plurality of electrical outlets by a communication signal line;
wherein each of said plurality of communication access points are associated with others of said plurality of communication access points through an Ethernet standard connection:
whereby communication is provided between any two of a plurality of devices wherein each of said plurality of devices is connected to one of said user terminals or connected to one of said access points through a connector mechanism.

2. The system according to claim 1, wherein one of said plurality of communication access points is a primary access point through which all signals from said plurality of user terminals pass.

3. The system according to claim 1, wherein said plurality of user terminals each include a microprocessor and at least two interfaces including at least one Ethernet interface and one power line carrier interface.

4. The system according to claim 1, where each of said plurality of access point are associated with other ones of said access points through an Ethernet hub structure.

5. The system according to claim 1, where each of said plurality of access point are associated with the other ones of said access points through an Ethernet switching device.

6. A method for local area network communications comprising the steps of:
providing a plurality of communication access points in a corresponding plurality of logical wiring centers of a low-voltage AC power wiring structure;
providing a plurality of user terminals each connected to respective ones of a plurality of electrical outlets of said low-voltage AC power wiring structure; and
providing a Ethernet standard connection for associating each of said plurality of communication access points with other ones of said plurality of communication access points;
providing communication between any two of a plurality of devices wherein each of said plurality of devices is connected to one of said plurality of user terminals or to one of said access points though a connection mechanism.

7. The method according to claim 6, including the further step of providing one of said plurality of communication access points as a primary access point through which all signals from said plurality of user terminals pass.

8. The method according to claim 6, including the step of providing each of said user terminals with a microprocessor and at least two interfaces including at least one Ethernet interface and one power line carrier interface.

9. The method according to claim 6, including the step of providing a Ethernet hub structure as said Ethernet standard connection.

10. The method according to claim 1, including the step of providing an Ethernet switching device as said Ethernet standard connection.

11. A system for local area network communications over a low-voltage AC power wiring structure including a plurality of logical wiring centers each associated with a plurality of electrical outlets, said system comprising:
a plurality of communication access points each installed in a respective one of said plurality of logical wiring centers, said logical wiring centers being connected with each other with Ethernet standard connections;
a plurality of user terminals outputting a communication signal through a connection to a respective one of said plurality of electrical outlets;
whereby communication is provided between any two of a plurality of devices wherein each of said plurality of devices is connected to one of said user terminals or the one of said communication access points though a connection mechanism.

12. The system according to claim 11, wherein one of said plurality of communication access points is a primary access point through which all signals from said plurality of user terminals pass.

13. The system according to claim 11, wherein each of said plurality of user terminals and each of said plurality of communication access points include a microprocessor and at least two interfaces including at least one Ethernet interface and one power line carrier interface.

14. A method for communication among a plurality of end points of a low-voltage AC power wiring structure, said method comprising the steps of:
inserting an electrical communication signal into an originating one of said end points to be sent to at least one destination end point;
passing said signal to at least one intermediate point associated with a wiring center for a first group of said end points of said low voltage AC power wiring structure;
providing Ethernet standard communication between said first intermediate point and at least a second intermediate point associated with at least a second wiring center for at least a second group of end points of said low-voltage AC power wiring structure;
whereby when said electrical communication signal is destined for only end points of said first group, said communication is passed entirely as a carrier signal on a power line of said low-voltage AC power wiring structure.
